(19) United States
(12) Patent Application Publication
(10) Pub. No.: US 2012/0001854 A1
(43) Pub. Date: Jan. 5, 2012

(54) Analog resistive multi-touch display screen

(75) Inventor: Jussi P. Tikkanen, Haukipudas (FI)

(73) Assignee: National Semiconductor Corporation, Santa Clara, CA (US)

(21) Appl. No.: 12/803,662

(22) Filed: Jul. 1, 2010

(51) Int. Cl. G06F 3/041

(52) U.S. Cl. 345/173

(57) ABSTRACT

A method is provided for supporting resistive multi-touch with a touch-sensitive display screen. The display screen includes a resistive network that varies depending on where the display screen is contacted. The display screen has a first plane resistance and a second plane resistance when the display screen is not contacted. The method includes detecting one or more objects contacting the display screen. The method also includes identifying coordinates of multiple contact points on the display screen based on a change in at least one of the plane resistances. The change is caused by one or more parallel resistances created in the display screen by the multiple contact points.

### TECHNICAL FIELD

This disclosure is generally directed to touch-sensitive display screens. More specifically, this disclosure relates to an analog resistive multi-touch display screen.

### BACKGROUND

Touch-sensitive display screens or “touch screens” are extremely popular in devices like mobile handsets and portable computers. A touch screen displays information to a user and receives user input when the user touches the screen. Two common types of touch screens are resistive and capacitive touch screens.

In a resistive touch screen, a resistive network forms different voltage dividers in the x and y directions depending on where the user touches the screen. Resistive touch screens are typically low-cost devices and work well with a stylus or while the user is wearing gloves. However, most resistive touch screens do not support “multi-touch,” meaning multiple objects touching the screen cannot be tracked simultaneously. Resistive touch screens that can support multi-touch usually require a large number of wires coupled to the screens in both the x and y directions to detect and track multiple objects. These types of resistive touch screens are not compliant with “four-wire” or “eight wire” touch screen technology, which uses only four or eight wires coupled to a touch screen to provide signals to and receive signals from the touch screen.

In a capacitive touch screen, the screen itself forms a capacitance that is altered depending on where a user (who has his or her own capacitance) touches the screen. Capacitive touch screens do support multi-touch, which allows users to perform multi-touch operations such as zooming or rotating. However, capacitive touch screens are usually not as accurate as resistive touch screens (at least for character recognition), and capacitive touch screens typically cannot be used with a stylus or while the user is wearing gloves.

### SUMMARY

This disclosure provides a method, system, and apparatus supporting resistive multi-touch display screens.

In a first embodiment, a method is provided for supporting resistive multi-touch with a touch-sensitive display screen. The display screen includes a resistive network that varies depending on where the display screen is contacted. The display screen has a first plane resistance and a second plane resistance when the display screen is not contacted. The method includes, detecting one or more objects contacting the display screen. The method also includes identifying coordinates of multiple contact points on the display screen based on a change in at least one of the plane resistances. The change is caused by one or more parallel resistances created in the display screen by the multiple contact points.

In a second embodiment, a system for supporting resistive multi-touch includes a touch-sensitive display screen having a resistive network that varies depending on where the display screen is contacted. The display screen has a first plane resistance and a second plane resistance when the display screen is not contacted. The system also includes a touch controller configured to identify coordinates of multiple contact points on the display screen based on a change in at least one of the plane resistances. The change is caused by one or more parallel resistances created in the display screen by the multiple contact points.

In a third embodiment, an apparatus for association with a resistive touch-sensitive display screen includes a controller configured to detect one or more objects contacting the touch-sensitive display screen. The display screen includes a resistive network that varies depending on where the display screen is contacted. The display screen has a first plane resistance and a second plane resistance when the display screen is not contacted. The controller is also configured to identify coordinates of multiple contact points on the display screen based on a change in at least one of the plane resistances. The change is caused by one or more parallel resistances created in the display screen by the multiple contact points.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIGS. 1A and 1B illustrate an example device having a resistive multi-touch display screen according to this disclosure;

FIGS. 2A and 2B illustrate example resistances formed in a resistive multi-touch display screen according to this disclosure;

FIGS. 3A and 3B illustrate example measurements of resistances in a resistive multi-touch display screen according to this disclosure;

FIG. 4 illustrates an example method for detecting and identifying coordinates of one or more touches of a resistive multi-touch display screen according to this disclosure;

FIGS. 5 through 8 illustrate more detailed example methods for detecting and identifying coordinates of one or more touches of a resistive multi-touch display screen according to this disclosure; and

FIGS. 9A through 9C illustrate example coordinates on a resistive multi-touch display screen according to this disclosure.

### DETAILED DESCRIPTION

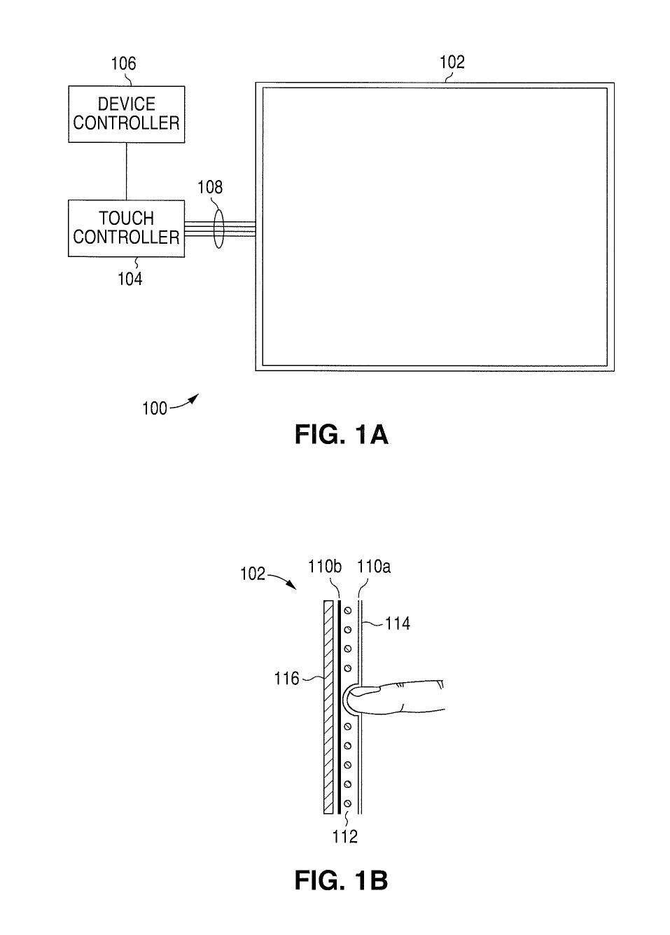

FIGS. 1A through 9C, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIGS. 1A and 1B illustrate an example device 100 having a resistive multi-touch display screen according to this disclosure. As shown in FIG. 1A, the device 100 includes a touch screen 102, a touch controller 104, and a device controller 106. The touch screen 102 presents various information to a user and receives user input from the user. For example, the touch screen 102 can present telephone or other user interfaces, display web pages, or display an alphanumeric keyboard or keypad to the user. The user can touch various areas of the touch screen 102 to make or receive telephone calls, view web pages, or invoke other functions.

The touch screen 102 represents an analog resistive touch-sensitive display. When a user touches the touch screen 102, the contact creates different voltage dividers in the touch screen 102, which can be used to determine coordinates of the contact point(s). Note that while FIGS. 1A and 1B show a user using his or her finger to contact the screen 102, the touch screen 102 can detect contact by other objects, such as a stylus. Moreover, the user could be wearing gloves or other clothing over his or her hand, and the contact with the touch screen 102 can still be detected. Details of an example resistive touch screen 102 are shown in FIG. 1B, which is described below.

The touch screen 102 could be used in any suitable device or system. For example, the touch screen 102 could form part of a mobile handset, such as a mobile telephone or a personal digital assistant. The touch screen 102 could also form part of a portable computing device, such as a notebook or laptop computer. The touch screen 102 could further form part of a desktop computer or other non-portable device. These examples are for illustration only, and the touch screen 102 could be used in any other device or system.

The touch controller 104 detects when the touch screen 102 is contacted by at least one object, such as a user's finger or stylus. The touch controller 104 also determines the location(s) of contact on the screen 102. When a single touch on the screen 102 is made, the touch controller 104 can identify the coordinates of the touch on the screen 102 (such as x and y coordinates). When multiple touches on the screen 102 are made simultaneously, the touch controller 104 can identify the coordinates of each touch on the screen 102. The touch controller 104 can output the coordinates to the device controller 106. The touch controller 104 includes any suitable structure for identifying coordinates of at least one object contacting a touch screen. The touch controller 104 could be implemented using software instructions executed by at least one processing unit, or the touch controller 104 could be implemented using hardware components such as a hardware state machine. As particular examples, the touch controller 104 could represent a microprocessor, microcontroller, digital signal processor (DSP), application specific integrated circuit (ASIC), or field programmable gate array (FPGA).

The device controller 106 controls the operation of the device 100 in which the touch screen 102 resides. The device controller 106 can perform a wide variety of operations depending on the device 100. The functions performed by the device controller 106 can be based on the coordinates of one or more objects touching the screen 102. For example, in a mobile handset, the device controller 106 could initiate outgoing telephone calls, answer incoming telephone calls, allow a user to surf the Internet, and allow the user to send and receive email messages. The device controller 106 includes any suitable structure for controlling a larger device in which the touch screen 102 resides. As examples, the device controller 106 could represent a microprocessor, microcontroller, DSP, ASIC, or FPGA.

In particular embodiments, the device controller 106 represents a microprocessor or other device that can enter at least one low-power mode of operation. When in this mode, the touch controller 104 can scan the touch screen 102 and detect if and when the touch screen 102 is contacted by an object. When contact is detected, the touch controller 104 can send an interrupt or other signal to the device controller 106, causing the device controller 106 to exit the low-power mode of operation.

The touch controller 104 is coupled to the touch screen 102 using a connector 108, which in this example represents a four-wire connector. The connector 108 can be used to provide voltage or current signals to the touch screen 102 and receive voltage or current signals from the touch screen 102. This allows the touch controller 104 to, for example, send signals to drive the touch screen 102 and receive signals that vary based on where the touch screen 102 is contacted. Note that the use of a four-wire connector is for illustration only and that any other suitable connector, such as an eight-wire connector, could be used.

In this example, the touch screen 102 is a resistive touch display, and the touch controller 104 includes or otherwise implements logic supporting multi-touch detection. The touch controller 104 can therefore detect and track multiple objects contacting the touch screen 102. This allows, for example, the user to use two fingers to invoke operations like zoom in, zoom out, and rotate. Moreover, this can be accomplished using a reduced number of wires connected to the touch screen 102, such as standard four-wire or eight-wire connectors.

As shown in FIG. 1B, an example embodiment of the touch screen 102 includes two conductive films 110a-110b that are separated from each other by insulative spacer dots 112. The conductive films 110a-110b generally denote coatings or other films of conductive material that are substantially or completely transparent. The conductive films 110a-110b could be formed from any suitable material(s), such as indium tin oxide (ITO). The insulative spacer dots 112 electrically separate the conductive films 110a-110b unless contact with an external object occurs. The insulative spacer dots 112 can have any suitable shape(s) and are formed from any suitable dielectric material(s). An outer membrane 114 covers the conductive film 110a and generally protects the underlying components of the touch screen 102. The outer membrane 114 could represent a flexible hard-coated membrane. The components 110a-110b, 112, 114 reside over an underlying substrate 116, such as a glass substrate.

When a user's finger or other object contacts the touch screen 102, the membrane 114 and the conductive film 110a move towards the conductive film 110b. When the conductive films 110a-110b touch, this forms an electrical, path between the conductive films 110a-110b. The conductive films 110a-110b form a resistive network, and the resistive network changes based on where the screen 102 is contacted. As described below, the electrical path can be used to detect where at least one object has contacted the touch screen 102. When the object is removed from the touch screen 102, the insulative spacer dots 112 help to push the conductive films 110a-110b apart and break the electrical path.

Although FIGS. 1A and 1B illustrate one example of a device 100 having a resistive multi-touch display screen, various changes may be made to FIGS. 1A and 1B. For example, the functional division in FIG. 1A is for illustration only. Various components in FIG. 1A could be combined, further subdivided, or omitted and additional components could be added according to particular needs. As a specific example, the functionality of the touch controller 104 could be incorporated into the device controller 106. Also, while FIG. 1B illustrates an example structure of a resistive touch screen, other structures could be used, such as one having a different mechanism to separate the conductive films.

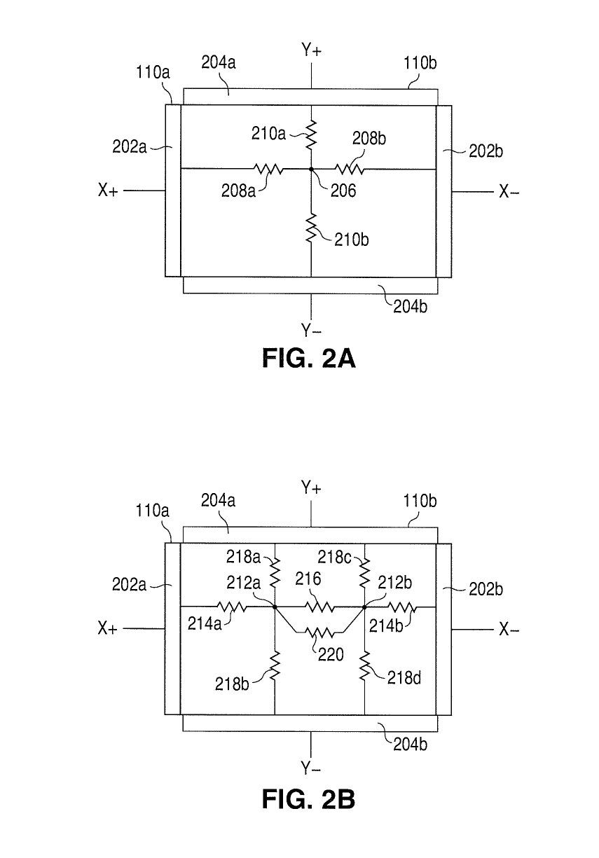

FIGS. 2A and 2B illustrate example resistances formed in a resistive multi-touch display screen according to this disclosure. In particular, FIG. 2A illustrates example resistances formed during a single touch of the touch screen 102, and FIG. 2B illustrates example resistances formed during multiple simultaneous touches of the touch screen 102.

As shown in FIG. 2A, the conductive film 110a is coupled to two wires X+ and X− by two terminals 202a-202b. The terminals 202a-202b may be formed across all or a substantial portion of the touch screen 102 in the vertical direction as seen in FIG. 2A. Similarly, the conductive film 110b is coupled to two wires Y+ and Y− by two terminals 204a-204b. The terminals 204a-204b may be formed across all or a substantial portion of the touch screen 102 in the horizontal direction as seen in FIG. 2A. Each terminal 202a-202b, 204a-204b includes any suitable structure formed from any suitable conductive material(s). The X+, X−, Y+, and Y− wires may represent wires in the four-wire connector 108. Note that a different arrangement of terminals or connections to wires could be used to support different connectors 108, such as eight-wire connectors.

When an object contacts the touch screen 102 at a single point 206, this effectively creates two resistances 208a-208b in the horizontal (x) direction and two resistances 210a-210b in the vertical (y) direction. The resistances 208a-208b form a first voltage divider, and the resistances 210a-210b form a second voltage divider. The value of each resistance 208a-208b, 210a-210b varies depending on where the point 206 is located on the screen. These resistances 208a-208b, 210a-210b can therefore be used to identify the coordinates of the point 206. For instance, applying a voltage to the X+ wire and grounding the X− wire can generate a voltage at the point 206, and this voltage can be measured using the Y+/Y− wire(s) and used to calculate the x coordinate of the point 206. Similarly, applying a voltage to the Y+ wire and grounding the Y− wire can generate a voltage at the point 206, and this voltage can be measured using the X+/X− wire(s) and used to calculate the y coordinate of the point 206. The x and y coordinates could be provided to the device controller 106 or used in any suitable manner.

When two objects contact the touch screen 102 at two points 212a-212b as shown in FIG. 2B, this leads to the creation of various resistances 214a-214b, 216, 218a-218d, 220 that create multiple dividers. The resistance 214a forms between the point 212a and the terminal 202a, and the resistance 214b forms between the point 212b and the terminal 202b. The resistance 216 forms between the points 212a-212b in the horizontal direction. The resistances 218a-218b are formed by the point 212a between the terminals 204a-204b in the vertical direction, and the resistances 218c-218d are formed by the point 212b between the terminals 204a-204b in the vertical direction. The resistance 220 forms between the points 212a-212b in the vertical direction.

As shown here, parallel resistances can form in the touch screen 102, such as resistances 216 and 220. Since parallel resistances have a lower overall resistance than each individual resistance, this lowers the overall resistance in the x plane (between terminals 202a-202b) and/or in the y plane (between terminals 204a-204b). The description below provides a technique for determining the coordinates of the multiple points 212a-212b based on the resistance drop in the x and/or y plane due to parallel resistances created by multiple contacts with the touch screen 102.

Although FIGS. 2A and 2B illustrate examples of the resistances formed in a resistive multi-touch display screen, various changes may be made to FIGS. 2A and 2B. For example, in FIG. 2B, it is assumed that the points 212a-212b have the same vertical (y) coordinate, which reduces the number of resistances formed across the touch screen 102 in the horizontal direction. Note, however, that the points 212a-212b could have different vertical coordinates that can be identified.

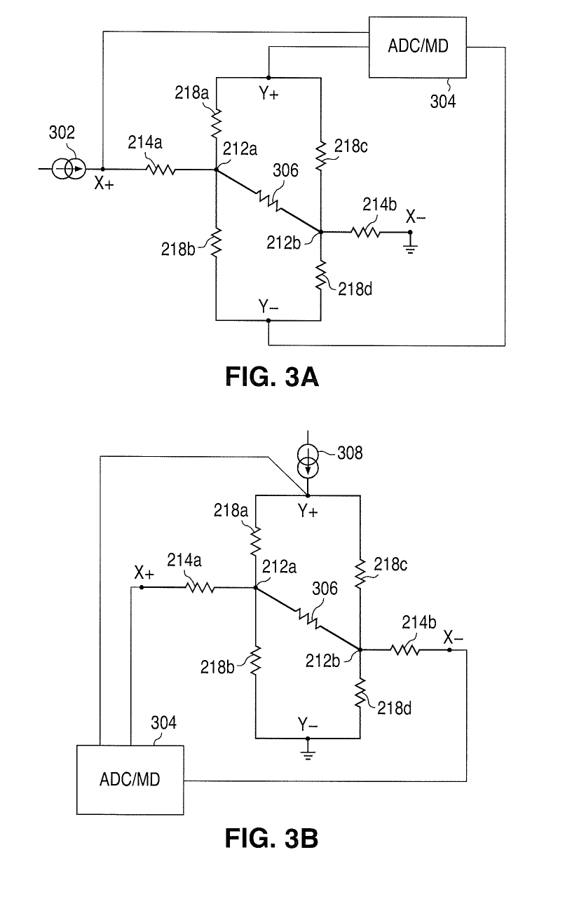

FIGS. 3A and 3B illustrate example measurements of resistances in a resistive multi-touch display screen according to this disclosure. In particular, FIG. 3A illustrates measurement of the horizontal (x) coordinates of multiple touches, and FIGURE 3B illustrates measurement of the vertical (y) coordinates of multiple touches.

As shown in FIG. 3A, the X+ wire can be coupled to a current source 302, which represents any suitable source of current. The current source 302 could provide a constant current to the touch screen 102, such as 15 mA. The X− wire is coupled to ground. In this condition, one or both of the wires Y+ and Y− can be coupled to an analog-to-digital converter (ADC) or other measurement device (MD) 304 for measuring the voltage on the Y+ and/or Y− wire. The measurements can then be used to identify the x coordinates of the points 212a-212b. Here, the current represents a drive signal, and the voltage represents a sense signal. The ADC or other measurement device 304 can also be coupled to the X+ wire in order to take measurements associated with the total resistance of the x plane. Note that the resistances 216 and 220 are shown here as a resistance 306, which denotes the overall resistance of the parallel resistances 216 and 220. Also note that the use of a current source 302 is for illustration only. In other embodiments, the X− wire could be coupled to a current sink, such as a 15 mA sink. Further note that the ADC or other measurement device 304 could form a part of the touch controller 104 or reside external to the touch controller 104. The ADC 304 could represent a single-ended device or a differential device.

As shown in FIG. 3B, the Y+ wire is coupled to a current source 308, which represents any suitable source of current. The current source 308 could provide a constant current to the touch screen 102, such as 15 mA. The Y− wire is coupled to ground. In this condition, one or both of the wires X+ and X− can be coupled to the ADC or other measurement device 304 for measuring the voltage on the X+ and/or X− wire. The measurements can then be used to identify the y coordinates of the points 212a-212b. The ADC or other measurement device 304 can also be coupled to the Y+wire in order to take measurements associated with the total resistance of the y plane. Note that the current source 308 could represent the current source 302, or the current source 308 could be a separate current source that provides the same amount of current or a different amount of current compared to the current source 302. Also note that the use of a current source 308 is for illustration only. In other embodiments, the Y− wire could be coupled to a current sink, such as a 15 mA sink.

Although FIGS. 3A and 3B illustrate examples of measurements of resistances formed in a resistive multi-touch display screen, various changes may be made to FIGS. 3A and 3B. For example, while the use of one or more constant current sources or sinks to generate drive signals and the measurement of voltages as sense signals are described above, various resistances in the touch screen 102 could be measured using any other suitable technique. As a particular example, one or more constant voltage sources (such as 1.8V sources) could be used, and currents can be measured to calculate the resistances in the screen 102. Also, while a single ADC 304 is shown here, multiple ADCs could be used.

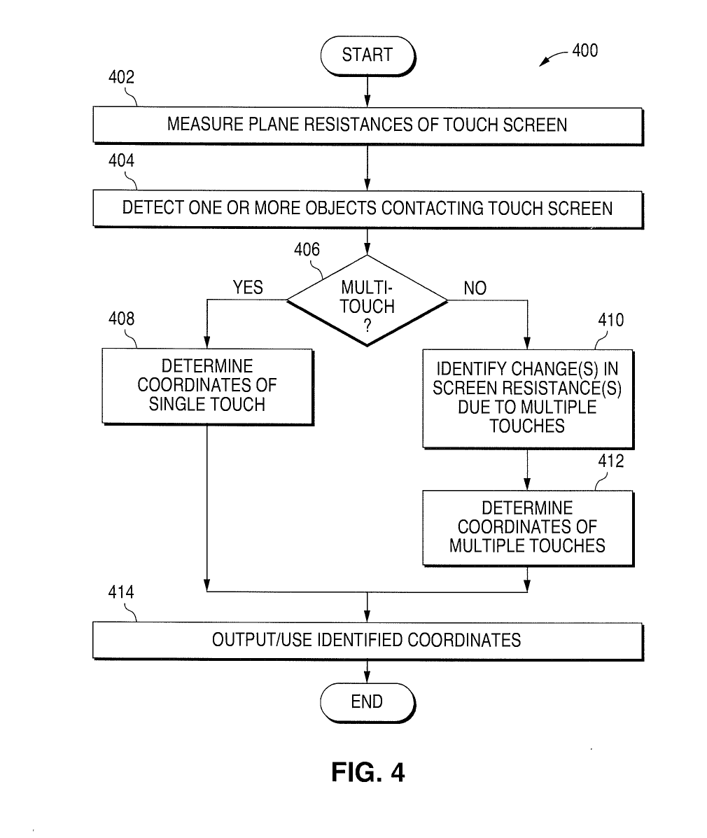

FIG. 4 illustrates an example method 400 for detecting and identifying coordinates of one or more touches of a resistive multi-touch display screen according to this disclosure. Plane resistances of the x and y planes are measured at step 402. This could include, for example, the touch controller 104 activating a constant current source or sink on the X+/X− wires to generate a drive signal and using a voltage measurement on the X+ and/or X− wire as a sense signal to determine the x plane resistance. This could also include the touch controller 104 activating a constant current source or sink on the Y+/Y− wires to generate a drive signal and using a voltage measurement on the Y+ and/or Y− wire as a sense signal to determine the y plane resistance.

One or more objects contacting the touch screen are detected at step 404. This could include, for example, the touch controller 104 activating a constant current source or sink on the X+/X− wires to generate a drive signal and measuring a voltage on the Y+ and/or Y− wire as a sense signal. This could also include the touch controller 104 activating a constant current source or sink on the Y+/Y− wires to generate a drive signal and measuring a voltage on the X+ and/or X− wire as a sense signal. If no touch is present, the measured voltages should be equal to approximately zero. When at least one touch is present, at least one of the measured voltages should be greater than zero.

A decision is made whether the detected touch is a multi-touch event at step 406. This could occur in various ways. For example, the x and y plane resistances could be measured again, and a determination could be made whether either plane resistance has fallen significantly. As shown in FIGS. 3A and 3B, the parallel resistance 304 depends on the distance between the contacted points 212a-212b. Since the parallel resistance 304 is smaller than the resistance 216 in the horizontal direction and/or the resistance 220 in the vertical direction, this causes the plane resistance in the x and/or y direction to drop from its initial “no touch” resistance value to a lower value. A significant reduction in plane resistance may be caused by multiple touches, while a single touch may lead to little or no reduction in plane resistance. In these embodiments, a multi-touch event can be detected by determining whether the reduction in x or y plane resistance is greater than a threshold value. In other embodiments, the touch controller 104 can begin identifying the coordinates of the touch(es), and a determination whether multiple touches are occurring can be made during the identification of the coordinates.

If the detected touch is not a multi-touch event, the coordinates of a single touched point are identified at step 408. This could include, for example, the touch controller applying a current on the X+/X− wires to generate a drive signal and measuring a voltage on the Y+ and/or Y− wires as a sense signal. This could also include the touch controller applying a current on the Y+/Y− wires to generate a drive signal and measuring a voltage on the X+ and/or X− wires as a sense signal. The measured voltages can be used to identify the voltage dividers formed by the resistances 208a-208b and 210a-210b, which indicates the location of the single touch.

If the detected touch is a multi-touch event, one or more changes in the plane resistance(s) are identified at step 410. As noted above, these differences are caused by the parallel resistances created by the multiple touches. The decrease in plane resistance is proportional to the touch area and the distance between the points 212a-212b, which allows for the detection of both touch pressure and multi-touch. Touch pressure denotes the pressure by which an object contacts the touch screen 102, where greater touch pressure can result in larger areas of the films 110a-110b contacting each other. Using changes in the horizontal and vertical plane resistances, the coordinates of the multiple touches are determined at step 412. This could include, for example, the touch controller 104 applying a current on the X+/X− wires to generate a drive signal and measuring a voltage on the Y+ and/or Y− wire as a sense signal (and vice versa). This could also include the touch controller 104 using the voltage measurements and the change(s) in plane resistances to calculate the coordinates of the multiple touches. As described in more detail below, this could further include the touch controller 104 calculating one or more correction factors. The parallel resistance formed by the resistances in the screen 102 (such as resistances 218a-218d) can create errors in the measurement of the coordinates for the points 212a-212b. With a known proportion of the total x resistance and the total y resistance (which could be expressed as the dimensions of the touch screen 102), correction factors can be calculated using the plane resistances in the x and y directions as measured during the “no touch” condition of step 402. These correction factors can be used to reduce the error in the determination of the coordinates.

The identified coordinates are output or used in some manner at step 414. This could include, for example, the touch controller 104 providing the identified coordinates or sets of coordinates to the device controller 106.

Although FIG. 4 illustrates one example of a method 400 for detecting and identifying coordinates of one or more touches of a resistive multi-touch display screen, various changes may be made to FIG. 4. For example, while shown as a series of steps, various steps in FIG. 4 could overlap, occur in parallel, occur in a different order, or occur multiple times. Also, as noted above, while the use of constant currents as drive signals to measure resistance is one possible technique, other techniques for measuring resistance could also be used.

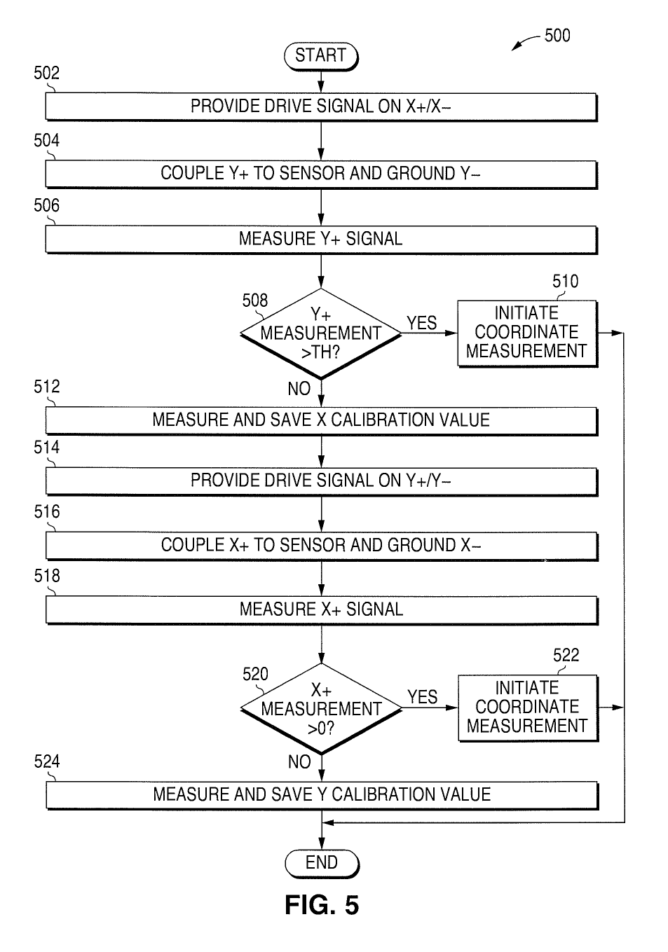

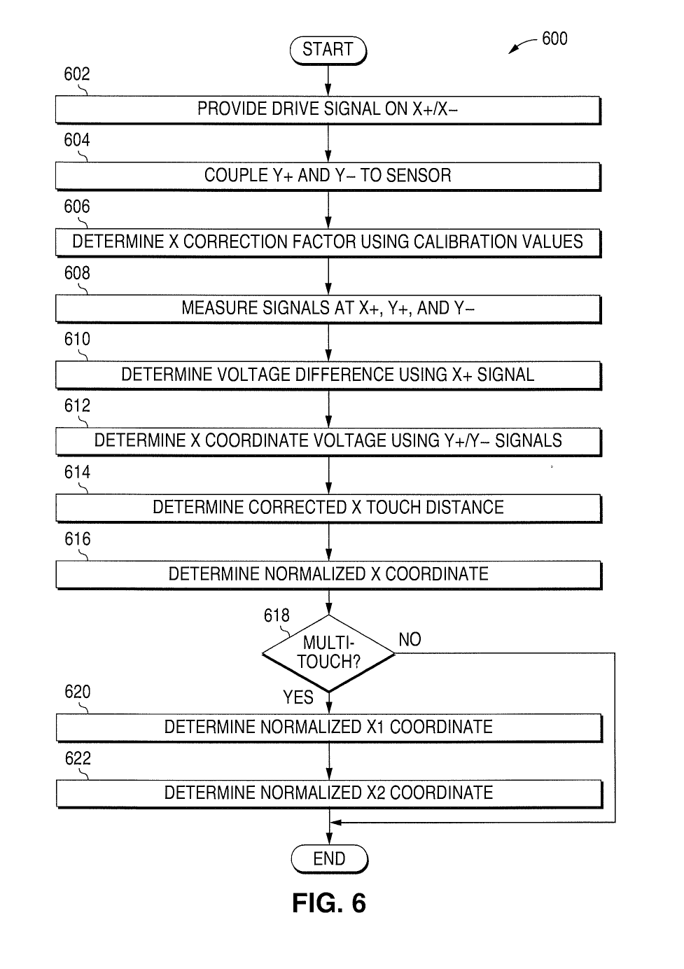

FIGS. 5 through 8 illustrate more detailed example methods for detecting and identifying coordinates of one or more touches of a resistive multi-touch display screen according to this disclosure. In particular, FIG. 5 illustrates an example process for performing touch detection, meaning this process is used to detect when at least one object contacts the touch screen 102. FIGS. 6 through 8 illustrate an example process for identifying the coordinates of the contacted point(s) on the touch screen 102.

As shown in FIG. 5, a touch detection method 500 scans the x and y planes one at a time in order to detect when a touch occurs. If a touch is detected, the touch controller 104 can initiate the coordinate measurement process of FIGS. 5 through 7. If no touch is detected, the touch controller 104 can take plane resistance measurements, which can be saved as calibration values U0x and U0y. These calibration values can be used to calculate the correction factors for reducing errors in the coordinate measurement process.

A drive signal is provided on the X+/X− wires at step 502. This could include, for example, the touch controller 104 sourcing a constant current on the X+wire or sinking a constant current on the X− wire. The Y+ wire is coupled to a sensor and the Y− wire is grounded at step 504. This could include, for example, the touch controller 104 coupling the Y+ wire to the ADC 304. A sense signal on the Y+ wire is measured at step 506. This could include, for example, the ADC 304 converting the voltage on the Y+ wire into a digital value. A determination is made whether the measured Y+ signal is greater than a threshold value TH (such as zero) at step 508. If so, at least one object is touching the screen 102, and the coordinate measurement process is initiated at step 510. Otherwise, no touch of the screen is occurring, and an x calibration value is measured and saved at step 512. This could include, for example, the touch controller 104 determining the value of U0x by measuring the voltage on the X+ wire. If the drive signal is a constant current, the voltage on the X+ wire can be measured and is indicative of the plane resistance in the x direction.

Another drive signal is provided on the Y+/Y− wires at step 514. This could include, for example, the touch controller 104 sourcing a constant current on the Y+ wire or sinking a constant current on the Y− wire. The drive signal provided at step 514 may or may not equal the drive signal provided at step 502. The X+ wire is coupled to a sensor and the X− wire is grounded at step 516. This could include, for example, the touch controller 104 coupling the X+ wire to the ADC 304. A sense signal on the X+ wire is measured at step 518. This could include, for example, the ADC 304 converting the voltage on the X+ wire into a digital value. A determination is made whether the measured X+ signal is greater than a threshold value TH (such as zero) at step 520. If so, at least one object is touching the screen 102, and the coordinate measurement process is initiated at step 522. Otherwise, no touch of the screen is occurring, and a y calibration value is measured and saved at step 524. This could include, for example, the touch controller 104 determining the value of U0y by measuring the voltage on the Y+ wire. If the drive signal is a constant current, the voltage on the Y+ wire can be measured and is indicative of the plane resistance in the y direction.

The method 500 shown in FIG. 5 could be repeated any number of times and at any suitable interval(s). In some embodiments, the touch controller 104 can perform the method 500 even when the device controller 106 is in a low-power mode. The touch controller 104 can send an interrupt or other signal to the device controller 106 when a touch on the screen 102 is detected.

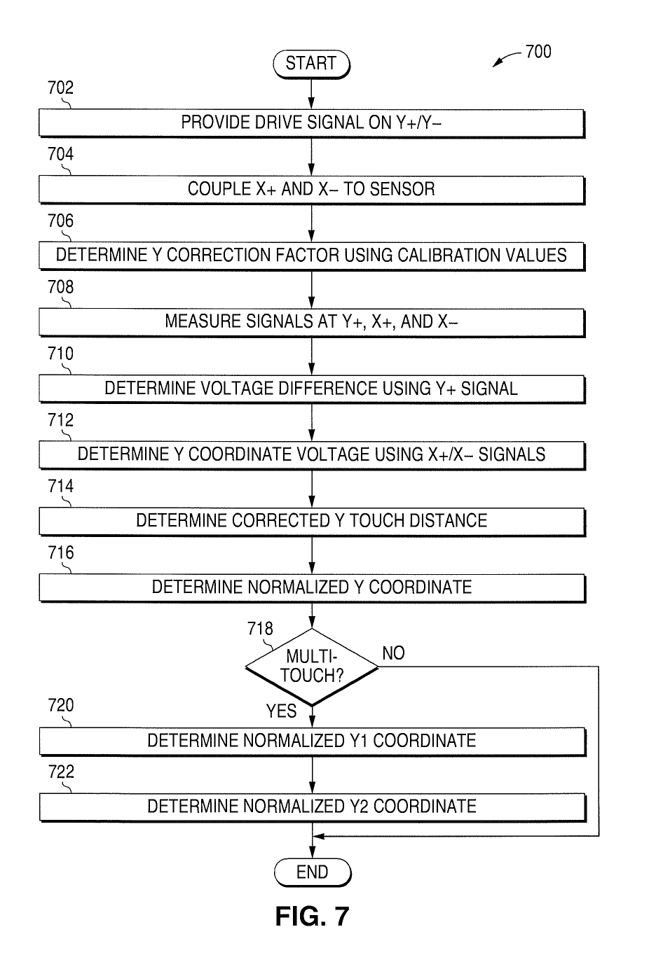

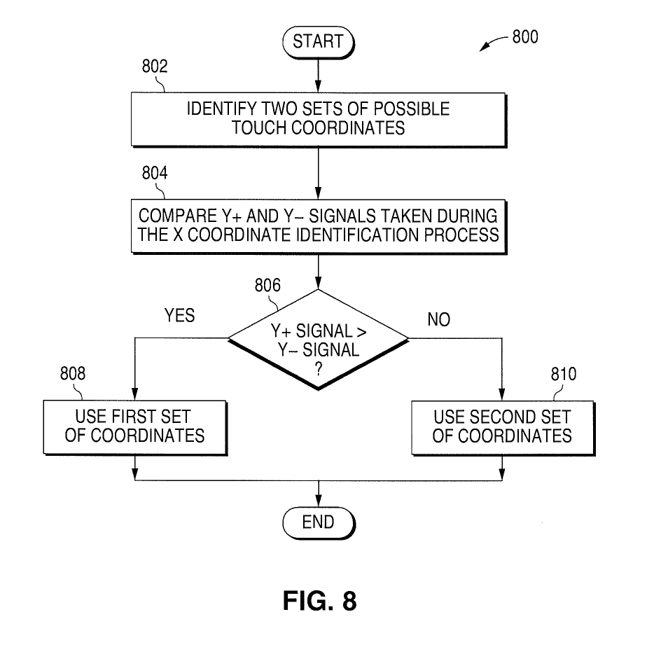

The coordinate measurement process can involve the various steps shown in FIGS. 6 through 8. FIG. 6 illustrates an example method 600 for calculating an x coordinate of one or multiple touches on the touch screen 102. FIG. 7 illustrates an example method 700 for calculating a y coordinate of one or multiple touches on the touch screen 102. FIG. 8 illustrates an example method 800 for selecting between two possible sets of coordinates when multiple touches on the touch screen 102 occur.

As shown in FIG. 6, the method 600 includes providing a drive signal on the X+/X− wires at step 602. This could include, for example, the touch controller 104 sourcing a constant current on the X+ wire or sinking a constant current on the X− wire. The Y+ and Y− wires are coupled to a sensor at step 604. This could include, for example, the touch controller 104 coupling the Y+ and Y− wires to the ADC 304.

A correction factor for the x coordinate is determined using the previously-identified calibration values at step 606. This could include, for example, the touch controller 104 calculating a correction factor cfx based on the U0x and U0y values identified during the method 500. In particular embodiments, the correction factor cfx could be calculated as:

$$cfx = \frac{U 0 x}{U 0 x - \frac{U 0 y / 2 * U 0 x / 2}{U 0 y / 2 + U 0 x / 2}} .$$

Sense signals on the X+, Y+, and Y− wires are measured at step 608. This could include, for example, the touch controller 104 using the ADC 304 to measure the sense signals. The signal on the X+ wire may be denoted U1x, the signal on the Y+ wire may be denoted U2x, and the signal on the Y− wire may be denoted U3x. A voltage difference is determined using the X+ signal measurement at step 610. In particular embodiments, the voltage difference dx could be calculated as:

dx=U0x−U1x.

An x coordinate voltage is determined using the Y+ and Y− signal measurements at step 612. In particular embodiments, the x coordinate voltage Ux could be calculated as:

Ux=(U2x+U3x+dx)/2.

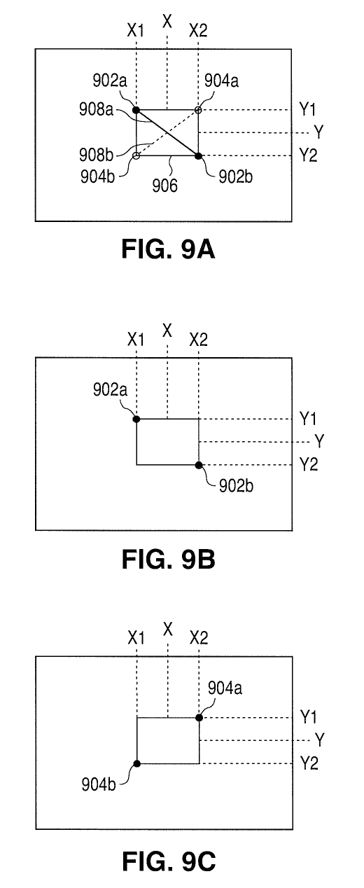

A corrected touch distance is determined at step 614. The corrected touch distance is associated with the touch area or the distance between two touched points in the x direction. For example, as shown in FIG. 9A, when two points 902a-902b or 904a-904b are touched on the touch screen 102, the points define a touch area 906 and a distance 908a or 908b between the points. The corrected touch distance represents the difference between the X1 and X2 coordinates of the two contacted points. In particular embodiments, the corrected touch distance tdx could be calculated as:

tdx=dx*cfx.

Note that the value of tdx can be compared to a threshold value to determine whether a single point or multiple points are contacted on the touch screen 102. When a single point is contacted on the touch screen 102, the value of tdx may be at or near zero.

A normalized x coordinate is determined at step 616, and a determination is made whether a multi-touch event is occurring at step 618. The normalized x coordinate may represent the x coordinate of a single touched point. If the value of tdx indicates that a single point is touched, the normalized x coordinate can be used as the x coordinate of the touch, and the method 600 can end. The normalized x coordinate may also represent the center x coordinate of multiple touch points as shown in FIG. 9A, meaning the normalized x coordinate lies directly between the X1 and X2 coordinates of the touched points. In particular embodiments, the normalized x coordinate X could be calculated as:

X=Ux/U0x.

When multiple points are being touched, normalized X1 and X2 coordinates are determined at steps 620-622. The normalized X1 and X2 coordinates represent the x coordinates of the two contacted points 902a-902b or 904a-904b as shown in FIG. 9A. In particular embodiments, the normalized X1 and X2 coordinates X1 and X2 could be calculated as:

X1=(Ux+tdx/2)/U0x

X2=(Ux−tdx/2)/U0x.

As shown here, the method 600 can be used to identify whether a single touch or multiple touches on the touch screen 102 are occurring. If a single touch occurs, the x coordinate X of the single touch can be determined. If two touches occur, the x coordinates X1 and X2 of the two touches can be determined.

The method 700 of FIG. 7 is used to determine a y coordinate of one or multiple touches on the touch screen 102. The method 700 is similar to the method 600 of FIG. 6, but the method 700 is done with respect to the y direction. A drive signal is provided on the Y+/Y− wires at step 702. This could include, for example, the touch controller 104 sourcing a constant current on the Y+ wire or sinking a constant current to the Y− wire. The drive signal used at step 702 may or may not be the same as the drive signal used at step 602. The X+ and X− wires are coupled to a sensor at step 704. This could include, for example, the touch controller 104 coupling the X+ and X− wires to the ADC 304.

A correction factor for the y coordinate is determined using the previously-identified calibration values at step 706. This could include, for example, the touch controller 104 calculating a correction factor cfy based on the U0x and U0y values identified during the method 500. In particular embodiments, the correction factor cfy could be calculated as:

$$cfy = \frac{U 0 y}{U 0 y - \frac{U 0 y / 2 * U 0 x / 2}{U 0 y / 2 + U 0 x / 2}} .$$

Sense signals on the Y+, X+, and X− wires are measured at step 708. This could include, for example, the touch controller 104 using the ADC 304 to measure the sense signals. The signal on the Y+ wire may be denoted U1y, the signal on the X+ wire may be denoted U2y, and the signal on the X− wire may be denoted U3y. A voltage difference is determined using the Y+ signal measurement at step 710. In particular embodiments, a voltage difference dy could be calculated as:

dy=U0y−U1y.

A y coordinate voltage is determined using the X+ and X− signal measurements at step 712. In particular embodiments, the y coordinate voltage Uy could be calculated as:

Uy=(U2y+U3y+dy)/2.

A corrected touch distance is determined at step 714. The corrected touch distance represents the difference between the Y1 and Y2 coordinates of the two contacted points. In particular embodiments, the corrected touch distance tdy could be calculated as:

tdy=dy*cfy.

Once again, note that the value of tdy can be compared to a threshold value to determine whether a single point or multiple points are contacted on the touch screen 102. When a single point is contacted on the touch screen 102, the value of tdy may be at or near zero.

A normalized y coordinate is determined at step 716, and a determination is made whether a multi-touch event is occurring at step 718. The normalized y coordinate may represent the y coordinate of a single touched point. If the value of tdy indicates that a single point is touched, the normalized y coordinate can be used as the y coordinate of the touch, and the method 700 can end. The normalized y coordinate may also represent the center y coordinate of multiple touch points as shown in FIG. 9A, meaning the normalized y coordinate lies directly between the Y1 and Y2 coordinates of the touched points. In particular embodiments, the normalized y coordinate Y could be calculated as:

Y=Uy/U0y.

When multiple points are being touched, normalized Y1 and Y2 coordinates are determined at steps 720-722. The normalized Y1 and Y2 coordinates represent the y coordinates of the two contacted points 902a-902b or 904a-904b as shown in FIG. 9A. In particular embodiments, the normalized Y1 and Y2 coordinates Y1 and Y2 could be calculated as:

Y1=(Uy+tdy/2)/U0y

Y2=(Uy−tdy/2)/U0y.

As shown here, the method 700 can be used to identify whether a single touch or multiple touches on the touch screen 102 have occurred. If a single touch occurs, the y coordinate Y of the single touch can be determined. If two touches occur, the y coordinates Y1 and Y2 of the two touches can be determined.

If two touches have occurred as shown in FIG. 9A, the methods 600 and 700 can be used to determine the coordinates X1, X2, Y1, and Y2 of the multiple touches. However, those coordinates identify two possible sets of touched points, namely points 902a-902b and points 904a-904b. A position detection process can therefore occur as shown in FIG. 8, which determines which set of touched points 902a-902b and 904a-904b is correct.

As shown in FIG. 8, two sets of possible touch coordinates are identified at step 802. This could include, for example, the touch controller 104 using the X1, X2, Y1, and Y2 coordinates identified during the methods 600 and 700. The Y+ and Y− sense signal measurements taken during x coordinate identification process are compared at step 804. This could include, for example, the touch controller 104 comparing the U2x and U3x values obtained during step 608 of the method 600. If the Y+ signal measurement (U2x) is greater than the Y− signal measurement (U3x) at step 806, a first set of coordinates is selected at step 808. The first set of coordinates identifies points 902a-902b as shown in FIG. 9B. Otherwise, a second set of coordinates is selected at step 910. The second set of coordinates identifies points 904a-904b as shown in FIG. 9C.

In this way, the touch controller 104 can detect when at least one touch occurs using the method 500 and, when no touch occurs, collect calibration data. Once at least one touch is detected, the touch controller 104 can use the methods 600 and 700 to identify the possible x and y coordinates of the touch(es). If a single touch has occurred, the x and y coordinates can be output to the device controller 106. If multiple touches have occurred, the touch controller 104 can use the method 800 to identify the appropriate set of coordinates for the multiple touches, and the appropriate set of coordinates can be output to the device controller 106. The device controller 106 could then perform various functions depending on the coordinate(s) of the touched point(s).

Although FIGS. 5 through 8 illustrate more detailed examples of methods for detecting and identifying coordinates of one or more touches of a resistive multi-touch display screen, various changes may be made to FIGS. 5 through 8. For example, while each figure illustrates a series of steps, various steps in each figure could overlap, occur in parallel, occur in a different order, or occur multiple times. Moreover, steps in different figures could overlap or occur in parallel. In addition, as noted above, while the use of constant currents as drive signals to measure resistance is one possible technique, other techniques for measuring resistance could also be used. Although FIGS. 9A through 9C illustrate examples of coordinates on a resistive multi-touch display screen, various changes may be made to FIGS. 9A through 9C. For example, two touched points could have the same x coordinate or the same y coordinate.

In some embodiments, the drive signals (such as constant currents) described above may be adaptive or dynamic. For example, the drive signals could be adjusted to obtain optimal measurements of a sense signal (such as voltage or current) on the X+, X−, Y+, and Y− wires. In particular embodiments, the drive signal can be set so as to scale the sense signal measurements into a range suitable for the ADC 304 being used. This may be useful, for instance, when the touch controller 104 can be used with different touch screens 102 having different resistive networks. Also, note that additional components can be added to support other functions in the device 100. For example, filtering components can be used to filter various signals in the device 100.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method for supporting resistive multi-touch with a touch-sensitive display screen, the display screen comprising a resistive network that varies depending on where the display screen is contacted, the display screen having a first plane resistance and a second plane resistance when the display screen is not contacted, the method comprising:
detecting one or more objects contacting the display screen; and
identifying coordinates of multiple contact points on the display screen based on a change in at least one of the plane resistances, the change caused by one or more parallel resistances created in the display screen by the multiple contact points.

2. The method of claim 1, further comprising:
when no contact on the display screen is detected, obtaining measurements associated with the plane resistances.

3. The method of claim 2, wherein obtaining the measurements associated with the plane resistances comprises:
applying a first drive signal to at least one of a first set of wires coupled to the display screen;
obtaining a first measurement of a first sense signal associated with the first plane resistance using at least one of the first set of wires;
applying a second drive signal to at least one of a second set of wires coupled to the display screen; and
obtaining a second measurement of a second sense signal associated with the second plane resistance using at least one of the second set of wires.

4. The method of claim 1, wherein detecting the one or more objects contacting the display screen comprises:
applying a drive signal to at least one of a first set of wires coupled to the display screen;
obtaining a measurement of a sense signal on at least one of a second set of wires coupled to the display screen; and
determining if the measurement exceeds a threshold value.

5. The method of claim 1, wherein identifying the coordinates of the multiple contact points comprises:
applying a first drive signal to at least one of a first set of wires coupled to the display screen;
obtaining a first measurement of at least one first sense signal on at least one of a second set of wires coupled to the display screen;
applying a second drive signal to at least one of the second set of wires;
obtaining a second measurement of at least one second sense signal on at least one of the first set of wires; and
determining the coordinates of the contact points using the first and second measurements.

6. The method of claim 5, wherein determining the coordinates of the multiple contact points comprises:
calculating at least one correction factor based on measurements associated with the first and second plane resistances; and
determining the coordinates of the contact points using the at least one correction factor.

7. The method of claim 6, wherein determining the coordinates of the contact points using the at least one correction factor comprises:
identifying a distance between two contact points along a first axis using a correction factor associated with the first axis; and
determining the coordinates of the contact points using the distance.

8. The method of claim 7, wherein determining the coordinates of the contact points using the distance comprises:
determining a center coordinate between the contact points along the first axis;
determining a first coordinate of a first of the contact points along the first axis using the center coordinate and the distance; and
determining a first coordinate of a second of the contact points along the first axis using the center coordinate and the distance.

9. The method of claim 8, wherein determining the coordinates of the contact points further comprises:
identifying a second coordinate of the first contact point along a second axis; and
identifying a second coordinate of the second contact point along the second axis.

10. The method of claim 9, wherein:
the first coordinates and the second coordinates define two possible coordinate sets for the contact points; and
the method further comprises selecting one of the two coordinate sets as actual coordinates for the contact points.

11. A system for supporting resistive multi-touch comprising:
a touch-sensitive display screen comprising a resistive network that varies depending on where the display screen is contacted, the display screen having a first plane resistance and a second plane resistance when the display screen is not contacted; and
a touch controller configured to identify coordinates of multiple contact points on the display screen based on a change in at least one of the plane resistances, the change caused by one or more parallel resistances created in the display screen by the multiple contact points.

12. The system of claim 11, wherein the touch controller is further configured to, when no contact on the display screen is detected, obtain measurements associated with the plane resistances by:
applying a first drive signal to at least one of a first set of wires coupled to the display screen;
obtaining a first measurement of a first sense signal associated with the first plane resistance using at least one of the first set of wires;
applying a second drive signal to at least one of a second set of wires coupled to the display screen; and
obtaining a second measurement of a second sense signal associated with the second plane resistance using at least one of the second set of wires.

13. The system of claim 11, wherein the touch controller is configured to identify the coordinates of the multiple contact points by:
applying a first drive signal to at least one of a first set of wires coupled to the display screen;
obtaining a first measurement of at least one first sense signal on at least one of a second set of wires coupled to the display screen;
applying a second drive signal to at least one of the second set of wires;
obtaining a second measurement of at least one second sense signal on at least one of the first set of wires; and
determining the coordinates of the contact points using the first and second measurements.

14. The system of claim 13, wherein the touch controller is configured to determine the coordinates of the contact points by:
calculating a correction factor based on measurements associated with the first and second plane resistances;
identifying a distance between two contact points along a first axis using the correction factor;
determining a center coordinate between the two contact points along the first axis;
determining a first coordinate of a first of the contact points along the first axis using the center coordinate and the distance; and
determining a first coordinate of a second of the contact points along the first axis using the center coordinate and the distance.

15. The system of claim 14, wherein the touch controller is configured to determine the coordinates of the contact points further by:
identifying a second coordinate of the first contact point along a second axis;
identifying a second coordinate of the second contact point along the second axis, wherein the first coordinates and the second coordinates define two possible coordinate sets for the contact points; and
selecting one of the two coordinate sets as actual coordinates for the contact points.

16. The system of claim 11, wherein the touch controller is coupled to the touch-sensitive display screen by one of: a four-wire connector and an eight-wire connector.

17. The system of claim 11, further comprising:
a device controller configured to invoke one or more specified functions based on the identified coordinates of the contact points.

18. An apparatus for association with a resistive touch-sensitive display screen, the display screen comprising a resistive network that varies depending on where the display screen is contacted, the display screen having a first plane resistance and a second plane resistance when the display screen is not contacted, the apparatus comprising:
a controller configured to detect one or more objects contacting the touch-sensitive display screen;
the controller also configured to identify coordinates of multiple contact points on the display screen based on a change in at least one of the plane resistances, the change caused by one or more parallel resistances created in the display screen by the multiple contact points.

19. The apparatus of claim 18, wherein the controller is configured to identify the coordinates of the multiple contact points by:
applying a first drive signal to at least one of a first set of wires coupled to the display screen;
obtaining a first measurement of at least one first sense signal on at least one of a second set of wires coupled to the display screen;
applying a second drive signal to at least one of the second set of wires;
obtaining a second measurement of at least one second sense signal on at least one of the first set of wires; and
determining the coordinates of the contact points using the first and second measurements.

20. The apparatus of claim 19, wherein the controller is configured to determine the coordinates of the contact points by:
calculating a correction factor based on measurements associated with the first and second plane resistances;
identifying a distance between two contact points along a first axis using the correction factor;
determining a center coordinate between the two contact points along the first axis;
determining a first coordinate of a first of the contact points along the first axis using the center coordinate and the distance;
determining a first coordinate of a second of the contact points along the first axis using the center coordinate and the distance;
identifying a second coordinate of the first contact point along a second axis;
identifying a second coordinate of the second contact point along the second axis, wherein the first coordinates and the second coordinates define two possible coordinate sets for the contact points; and
selecting one of the two coordinate sets as actual coordinates for the contact points.
